(19) United States
(12) Patent Application Publication
(10) Pub. No.: US 2025/0298236 A1
(43) Pub. Date: Sep. 25, 2025

(54) HOLOGRAPHIC DISPLAYS AND METHODS

(71) Applicant: VividQ Limited, London (GB)

(72) Inventors: Mark BRANNAN, London (GB); Alfred James NEWMAN, London (GB)

(21) Appl. No.: 19/230,736

(22) Filed: Jun. 6, 2025

Related U.S. Application Data
(63) Continuation of application No. PCT/GB2023/053330, filed on Dec. 20, 2023.

(30) Foreign Application Priority Data
Dec. 21, 2022 (GB) 2219403.9

(51) Int. Cl. G02B 26/08; G03H 1/00

(52) U.S. Cl. CPC G02B 26/0808; G02B 26/0833; G03H 1/0005; G03H 2001/0088; G03H 2222/12; G03H 2223/24

(57) ABSTRACT

An example holographic display may comprise an angularly dispersive micromirror array and an optical assembly configured to emit, towards the micromirror array, a first ray of light having a first wavelength and a second ray of light having a second wavelength, the second wavelength being different to the first wavelength. The first ray of light is incident upon the micromirror array at a first angle of incidence and the second ray of light is incident upon the micromirror array at a second angle of incidence, the second angle of incidence being different to the first angle of incidence by a predetermined amount to at least partially compensate for the dispersive effects of the micromirror array along an optical axis of the holographic display.

### CROSS-REFERENCE TO RELATED APPLICATIONS

This application is a continuation under 35 U.S.C. § 120 of International Application No. PCT/GB2023/053330, filed Dec. 20, 2023, which claims priority to GB Application No. GB2219403.9, filed Dec. 21, 2022, under 35 U.S.C. § 119(a). Each of the above-referenced patent applications is incorporated by reference in its entirety.

### TECHNICAL FIELD

The present invention relates to holographic displays and methods of displaying holograms.

### BACKGROUND

Holographic displays employing Computer-Generated Holographic (CGH) patterns produce an image by means of diffraction and interference of light. A diffraction pattern (also called a hologram) is calculated digitally from two or three dimensional data and forms a two or three-dimensional image in space when illuminated by coherent, or at least partially coherent, light. Unlike an image displayed on a conventional display, which is modulated only for amplitude, holographic displays can modulate phase and/or amplitude to result in an image which preserves depth information at a viewing position. The modulation in a holographic display can be achieved by passing at least partially coherent light (such as from a laser) via a Spatial Light Modulator (SLM). Such holographic displays can display both three-dimensional images (images of objects that appear to exist in three dimensions) and two-dimensional images (such as a conventional display but at a controllable apparent distance from the viewer) depending on the pattern of phase produced by the display.

To display a hologram, elements/pixels of the SLM are controlled according to a digital representation of the image to be displayed. A two or three-dimensional image provides an input and the image is then processed to generate hologram data which is used to drive the elements of the SLM. The hologram data therefore determines how each element of the SLM modulates the phase and/or amplitude of a light ray. An example SLM includes a micromirror array, such as a digital micromirror device (DMD). A micromirror array typically has an array of rotating micromirror “pixels” which can modulate incident light.

In holographic displays, it may be desirable to use illumination sources other than lasers, which can be more expensive and pose greater safety risks. For example, it may be desirable to use light emitting diodes (LEDs) in place of lasers. However, LEDs emit a beam of light comprising a broad range of wavelengths around the LED's dominant wavelength, and as such have a relatively large linewidth compared to a laser, for example. Due to the diffractive properties of micromirror arrays, the intensity of the incident beam from the LED is distributed over different angles at the output of the micromirror array by an amount depending on the beam's angle of incidence and spectral bandwidth around a dominant wavelength. These give rise to two dispersive effects which may be referred to as “inter-source dispersion” and “intra-source dispersion”, both of which degrade the quality of images or holograms formed by a micromirror array.

Accordingly, what are needed are methods and displays for reducing the effect of one or both of these dispersive effects in a holographic display.

### SUMMARY

Throughout the following discussion, the term “light ray” is to mean light having a single, well defined wavelength. In contrast, a “beam of light” or a “beam” is to mean light having multiple approximately parallel rays covering a given area, each of which may have the same or different wavelengths. Accordingly, a beam of light may comprise two or more rays of light having two or more different wavelengths. Furthermore, throughout the discussion two dispersive effects are referred to, these being “inter-source dispersion” and “intra-source dispersion”. “Inter-source dispersion” is caused by having a plurality of beams that each originate from a separate illumination source and each have a different dominant wavelength, resulting in each beam being reflected at a different angle when incident on a SLM that exhibits wavelength-dependent dispersive effects. “Intra-source dispersion” is caused by having a beam originating from a single broadband illumination source incident on a SLM that exhibits wavelength-dependent dispersive effects, resulting in rays from the same beam being reflected at a range of angles due to the spectral bandwidth of the source.

As discussed above, the diffractive properties of micromirror arrays may give rise to dispersive effects, meaning that two light rays having different wavelengths that are incident upon the micromirror array at the same angle of incidence would be reflected at different angles. In some circumstances, these two rays of light having different wavelengths may be emitted from a single illumination source, such as an LED. An LED therefore may emit a beam of light comprising two or more light rays, and as such, be termed a broadband emitter.

As is well known, a micromirror array may behave like a diffraction grating and as such, diffract incident light of a particular wavelength into different rays travelling in different directions as a diffraction pattern. Light reflected from each micromirror therefore interferes either constructively or destructively at different positions in space. As a result, the sum of the diffracted light waves from the micromirrors/slits creates a variation in light intensity depending on the observation point between peaks and troughs of intensity. This produces a diffraction pattern where each peak in intensity is associated with a diffraction order and is located at an angular distance (known as a diffraction angle) from a zero-order mode (in which a ray of light behaves according to the laws of reflection).

Furthermore, if the light incident upon the micromirror array/diffraction grating is not monochromatic, and contains two or more rays of light having different wavelengths, then a diffraction pattern will be produced for each wavelength. Because the diffraction angles are wavelength dependent, the peaks and troughs occur at different positions in space for each wavelength (here this assumes that the two or more rays of light are incident upon the micromirror array/diffraction grating at the same angle). This effectively means that the incident light is reflected in different directions. This reduces the quality of the produced replay field because the hologram is generated based on the assumption of a single wavelength—usually the dominant wavelength of the source.

To compensate for the dispersive effects experienced by light incident upon the micromirror array, the inventors have realised that by controlling the angle of incidence of each beam of light having the different wavelengths (the angle of incidence being upon the micromirror array), the dispersive effects can be “cancelled out”. In particular, the difference between the angles of incidence of two incident rays can be controlled to be equal to the angular difference between the diffraction angles for a particular order of the diffracted light from the micromirror array. This effectively re-aligns a desired diffraction order for the rays of light along a desired direction (such as an optical axis of the holographic display), thereby compensating for the dispersive effects introduced by the micromirror array. An optical axis of the holographic display may be any suitable direction or axis along which the light travels through a subsequent optical system. This may or may not be a direction normal to the surface of the micromirror array.

Thus, according to a first aspect of the present invention there is provided a holographic display for displaying a computer-generated hologram, the display comprising: an angularly dispersive micromirror array and an optical assembly configured to emit, towards the micromirror array, a first ray of light having a first wavelength and a second ray of light having a second wavelength, the second wavelength being different to the first wavelength. The first ray of light is incident upon the micromirror array at a first angle of incidence and the second ray of light is incident upon the micromirror array at a second angle of incidence, the second angle of incidence being different to the first angle of incidence by a predetermined amount to at least partially compensate for the dispersive effects of the micromirror array along an optical axis of the holographic display. In an example, “at least partially compensate for the dispersive effects of the micromirror array” means to “remove or reduce the dispersive effects introduced by the micromirror array”.

In some examples, fully compensating for the wavelength-dependent dispersive effects introduced by the micromirror array along the optical axis comprises adjusting the angle of incidence of every light ray incident upon the micromirror array so that a diffraction order of each ray of light substantially coincides along the optical axis.

As will become apparent below, the wavelength-dependent dispersive effects are compensated for along a particular direction, not necessarily in all directions.

The optical assembly may comprise one or more illumination sources. For example, a single illumination source, such as an LED, may emit light having a range of wavelengths, including the first ray of light having the first wavelength and the second ray of light having the second wavelength. In another example, a first illumination source, such as an LED or laser, may emit the first ray of light having the first wavelength and a second illumination source, such as an LED or laser, may emit the second ray of light having the second wavelength.

In certain examples, the micromirror array is a digital micromirror device (DMD), which comprises an array of controllable micromirrors. It will be appreciated that the present invention can apply to any micromirror array that exhibits wavelength-dependent dispersive effects. It will also be appreciated that the present invention can apply to any SLM that exhibits wavelength-dependent dispersive effects, such as an LCoS, a PLM, an LCD panel, a metasurface array. For some of these devices (for example an LCoS), the dispersive effects that would be compensated for would be less substantial, because light for all wavelengths is substantially reflected into the first order.

The optical axis direction may be normal to the plane of the micromirror array. To achieve this, the angle of incidence for both rays of light are approximately equal to twice the mirror tilt angle, but are still separated by the predetermined amount. The difference between the angles of incidence may be based on the difference between the first and second wavelengths.

In some examples, at least partially compensating for the wavelength-dependent dispersive effects introduced by the micromirror array along the optical axis comprises adjusting the angle of incidence of one or both of the rays so that the same diffraction order of each ray of light substantially coincides along the optical axis. This may be the case when the rays are emitted by the same illumination source, for example, and as such, both rays have a maximum intensity at the same diffraction order.

One method to control the angles of incidence of each ray of light incident upon the micromirror array involves the use of another angularly dispersive optical element arranged between the illumination assembly and the micromirror array. An “angularly dispersive optical element” is any optical element demonstrating wavelength-dependent effects, e.g. a diffraction grating, and this is not limited to optical elements containing a dispersive medium. An angularly dispersive optical element may be known as an “optical element with an angularly dispersive effect”. This optical element could be another micromirror array, such as a DMD, or a diffraction grating. The optical element should have a similar, or ideally identical, angularly dispersive effect as the micromirror array. That is, for a ray of light having the same wavelength, the diffraction pattern produced by the optical element should be substantially the same as the diffraction pattern produced by the micromirror array (i.e., the diffraction angles for each diffraction order are substantially the same). Thus, the two rays of light having the different wavelengths are incident upon the optical element and then diffract into different orders. For the first ray of light, one of these orders is incident upon the micromirror array at the first angle of incidence. For the second ray of light, one of these orders is incident upon the micromirror array at the second angle of incidence. Thus, they arrive at the micromirror array at different angles of incidence, and this difference is then compensated for by undergoing the same dispersive effects at the micromirror array (but in the opposite direction). This means that both (or all) the resultant rays of light emitted from the micromirror array have a diffraction order aligned along a desired direction (such as an optical axis).

Using such an optical element compensates for the dispersive effects of the micromirror array, which improves image quality of the replay field/reconstructed image. The optical element can be designed/constructed to accurately compensate for the dispersive effects of the micromirror array.

Accordingly, in some examples, the optical assembly comprises: an illumination assembly configured to emit the first ray of light having the first wavelength and the second ray of light having the second wavelength and an angularly dispersive optical element arranged between the illumination assembly and the micromirror array, such that the first and second rays of light travel from the illumination assembly to the micromirror array via the angularly dispersive optical element. The angularly dispersive optical element has a substantially equal and opposite angularly dispersive effect to that of the micromirror array, such that the first and second rays of light are transmitted from the optical element in different directions and are separated by an angle equal to the predetermined amount. Here “the first and second rays of light are transmitted from the optical element in different directions” may mean that the maximum intensities of the diffraction patterns for both rays are transmitted in different directions.

The optical element having a substantially equal and opposite angularly dispersive effect to that of the micromirror array means that the diffraction patterns produced by both the optical element and the micromirror array are substantially the same, and therefore have the peaks and troughs located at the same diffraction angles (for each wavelength). The effect is “opposite” because the optical element is arranged to reflect or diffract the rays of light in the opposite direction (about the normal to the optical element), compared to the micromirror array.

In some examples, the first and second rays of light are incident upon the optical element at the same angle of incidence. This may be the case when the optical element has properties (such as blaze angle/mirror tilt angle and pitch) identical to the micromirror array. In other examples, however, the first and second rays of light are incident upon the optical element at different angles. This may be the case when the optical element has optical properties only similar to the micromirror array, and so may benefit from additional compensation by varying the angles of incidence.

In some examples, the first and second rays of light travel from the optical element towards the micromirror array.

As mentioned, the first and second rays of light are transmitted from the optical element in different directions, which may mean that maximum intensity of the first ray of light and the maximum intensity of the second ray of light are arranged at different (wavelength dependent) diffraction orders and/or different angles.

In one example, the optical element is a diffraction grating, such as a reflective diffraction grating. As mentioned, diffraction gratings exhibit the same or similar dispersive effects as a micromirror. A diffraction grating may be manufactured or selected that has a substantially equal angularly dispersive effect to that of the micromirror array. This can be achieved by controlling properties of the grating, such as blaze angle and pitch. Diffraction gratings are particularly suitable because they are relatively inexpensive, relatively easy to manufacture and unlike some micromirror arrays, do not require active control (so contain no moving parts).

In some examples, the diffraction grating has a pitch substantially corresponding to a pixel pitch of the micromirror array and a blaze angle substantially corresponding to a mirror tilt angle of the micromirror array. Thus, the grating may behave, optically, almost identically to the micromirror array. This can result in the highest reconstructed image quality because the wavelength-dependent dispersive effects of the micromirror array are compensated for in an almost identical way. Furthermore, if two or more illumination sources are used, they can all be arranged such that the light from the illumination sources illuminate the diffraction grating with the same angle of incidence, reducing the complexity of the system.

In another example, the optical element is a second micromirror array, such as a DMD. A second micromirror array may have a substantially equal dispersive effect to that of the main/first micromirror array. For example, the first and second micromirrors arrays may be identical in model or type. As for the diffraction grating, the optical properties of a micromirror array can be controlled by adjusting the mirror tilt angle and pixel pitch. Use of a second micromirror array may be particularly suitable because it is most likely to behave in the same way as the other micromirror array. Furthermore, both micromirror arrays could be controlled together, and it may be simpler to obtain two micromirror arrays of the same model or type than it is to obtain a grating that has the same optical properties as a micromirror array.

In some examples, the micromirror array and the second micromirror array have substantially the same pixel pitch and mirror tilt angle. Thus, the second micromirror array may behave, optically, almost identically to the other micromirror array. Again, if two or more illumination sources are used, they can all be arranged such that the light from the illumination sources illuminate the second micromirror array with the same angle of incidence, reducing the complexity of the system.

As is well known, and will be shown illustratively later, a diffraction pattern has a series of peaks and troughs located at various diffraction angles, and the diffraction pattern has a Sinc² profile, where the peak of the Sinc² profile is the grating efficiency peak. Furthermore, it will be understood that a grating/micromirror array may be blazed for a particular wavelength, so that for a light ray having the blaze wavelength, the diffraction order having the highest intensity coincides exactly with the grating efficiency peak of the Sinc² profile. For other wavelengths not equal to the blaze wavelength, the diffraction order having the highest intensity is angularly offset from the grating efficiency peak of the Sinc² profile. Further still, diffraction patterns produced by diffraction gratings and micromirror arrays with angled surfaces/mirrors do not necessarily have the highest energy in the zero order, but instead have the maximum intensity located at a higher diffraction order. The diffraction order where the highest energy occurs is a function of wavelength. As an example, green light reflecting from a micromirror array may have a maximum intensity at the sixth (n=6) diffraction order, blue light may have a maximum intensity at the seventh (n=7) diffraction order, and red light may have a maximum intensity at the fifth (n=5) diffraction order.

In an example, green light emitted from an LED may comprise a first ray of light having a first wavelength and a second ray of light having a second wavelength, where the first and second wavelengths are different (by a small amount). If both rays of light are incident upon a micromirror array at the same angle of incidence, when they diffract from the micromirror array, the angular positions of the grating zero-order for each wavelength are aligned (as are the angular positions of the grating efficiency peak for each wavelength). However, the angular positions of their non-zero diffraction orders differ, meaning that the maximum intensities of the light rays are transmitted in different directions (this effect is visible in FIG. 3, and is discussed in more detail below). It is this effect that reduces the quality of the reconstructed image.

It is therefore desirable to offset one, or both of these rays of light (by controlling the angle of incidence(s), in the ways discussed above, such as using an optical element), so that along a desired direction (such as an optical axis), the diffraction orders having the highest intensity coincide.

As mentioned above, the angularly dispersive optical element is arranged relative to the micromirror array such that it has a substantially equal and opposite angularly dispersive effect to that of the micromirror array in order to at least partially compensate for the wavelength-dependent dispersive effects of the micromirror array. In practice, this can be achieved by having an optical element with similar optical properties to the micromirror. This can be achieved by ensuring that for each ray of light, the maximum intensity of the diffraction pattern occurs at the same diffraction order at both the optical element and the micromirror array (i.e., n_{OE}=n_{micromirror}, where n is the diffraction order) and by ensuring that the pitch of the optical element matches the pitch of the micromirror array p_{OE}=p_{micromirror}). However, the inventors have also found that the maximum intensities of the diffraction pattern do not need to occur at the same diffraction orders if the following relationship is satisfied: n_{micromirror}/p_{micromirror}−n_{OE}/p_{OE}, which still results in a high level of compensation of the angular dispersive effects. As mentioned, n_{OE} and n_{micromirror} are wavelength dependent. In an example, for green light, n_{micromirror}˜6, p_{micromirror}=5.4 μm, and as such, could be compensated for by using an optical element having n_{OE}˜1 and p_{OE}=0.9 μm.

Accordingly, in an example, peak (maximum) intensities of the first ray of light and the second ray of light, reflected from the micromirror array, occur substantially at a particular diffraction order, n_{micromirror}, of each ray and maximum intensities of the first ray of light and the second ray of light, reflected from the optical element, occur substantially at a particular diffraction order, n_{OE}, of each ray. The micromirror array has a pixel pitch, p_{micromirror} and the optical element has a pitch, p_{OE}, and n_{micromirror}/p_{micromirror}=n_{OE}/p_{OE}, such that the angularly dispersive optical element has a substantially equal and opposite angularly dispersive effect to that of the micromirror array.

In a particular example, n_{micromirror}=n_{OE} for each ray of light, and p_{micromirror}=p_{OE}. This covers a particular embodiment where the micromirror array and optical element have substantially the same optical properties. Such a configuration results in the highest reconstructed image quality.

As briefly mentioned, in some examples, the illumination assembly comprises an illumination source configured to emit a plurality of rays of light, each ray of light having a different wavelength, the plurality of rays of light including the first ray of light having the first wavelength and the second ray of light having the second wavelength. As example, the illumination source may be a (single) LED that emits light rays having wavelengths in a broad-spectrum including the first and second wavelengths. Thus, the present invention allows LEDs to be used in creating CGHs, by using an optical element to compensate for the broadband emission from a single LED source. Typical LEDs may have a linewidth of less than about 75 nm or less than about 50 nm. Accordingly, in an example, the first and second wavelengths are different by less than about 75 nm or less than about 50 nm.

In some examples, the illumination assembly comprises: (i) a first illumination source configured to emit a first plurality of rays of light having a first range of wavelengths, the first plurality of rays of light including the first ray of light having the first wavelength and the second ray of light having the second wavelength, and (ii) a second illumination source configured to emit a second plurality of rays of light having a second range of wavelengths, the second plurality of rays of light including a third ray of light having a third wavelength and a fourth ray of light having a fourth wavelength. Thus, there may be two or more illumination sources incident upon the optical element, and the optical element at least partially compensates for the dispersive effects of the micromirror array so that for each illumination source, the different rays of different wavelengths are aligned along the optical axis. As an example, the illumination sources may be different coloured LEDs, such as red, green or blue LEDs. This allows the reconstructed image to have a wider colour gamut. For example, three RGB illumination sources may provide a full colour reconstructed image. Thus, in some examples, the illumination assembly may further comprise a third illumination source configured to emit a third plurality of rays of light having a third range of wavelengths.

As mentioned above, in some cases, the optical element may not exactly correspond to the micromirror array, and may therefore have different wavelength-dependent dispersive effects to the micromirror array. This may result in an “imperfect” correction of the wavelength-dependent dispersive effects of the micromirror array for one or both of the illumination sources, meaning that additional corrections are beneficial. For example, the optical element that is selected may be more suitable to correct the dispersive effects for one of the wavelengths, and less suitable for the other. This would be case, for example, if the maximum intensity of each reflected ray occurs at different integer diffractive orders (i.e., they may differ by one or more). One way to correct for this is to adjust the angles of incidence for one or both illumination sources upon the optical element. In such an example, the first illumination source is arranged such that the first and second rays of light are incident upon the optical element at a third angle, and the second illumination source is arranged such that the third and fourth rays of light are incident upon the optical element at a fourth angle, wherein the third and fourth angles are different. In an example, the first illumination source is one of: a red LED, a green LED and a blue LED, and the second illumination source is one of: a red LED, a green LED and a blue LED and is different to the first illumination source.

Accordingly, in examples, to compensate for both the intra-dispersion and the inter-source dispersion, the illumination assembly comprises: a first illumination source configured to emit a first plurality of rays of light having a first range of wavelengths, the plurality of rays of light including the first ray of light having the first wavelength and the second ray of light having the second wavelength and a second illumination source configured to emit a second plurality of rays of light having a second range of wavelengths, the second plurality of rays of light including a third ray of light having a third wavelength and a fourth ray of light having a fourth wavelength. The third and fourth rays of light travel from the illumination assembly to the micromirror array via the angularly dispersive optical element. The angularly dispersive optical element has a substantially equal and opposite angularly dispersive effect to that of the micromirror array, such that the third and fourth rays of light are transmitted from the optical element in different directions and are separated by a second angle equal to a second predetermined amount to at least partially compensate for the dispersive effects of the micromirror array on the second plurality of rays along the optical axis of the holographic display. The first illumination source is arranged such that the first and second rays of light are incident upon the optical element at a third angle, and the second illumination source is arranged such that the third and fourth rays of light are incident upon the optical element at a fourth angle, wherein the third and fourth angles are different. Having the third and fourth angles different is such that the first, second, third and fourth rays of light are reflected from the micromirror array approximately along the optical axis.

As mentioned, in examples, the third and fourth rays of light are transmitted from the optical element in different directions and are separated by a second angle equal to a second predetermined amount. In the same way as discussed above for the first and second rays of light, the third ray of light is incident upon the micromirror array at one angle of incidence and the fourth ray of light is incident upon the micromirror array at another angle of incidence, the angles of incidence being different by the predetermined amount so as to at least partially compensate for the dispersive effects of the micromirror array along the optical axis of the holographic display.

The second predetermined amount may be related to the first predetermined amount (the angle between the first and second rays) by a wavelength dependent function. For example, although the values are different, the first and second predetermined amounts may be determined from the same function. The skilled person will be aware that the equation governing the dispersive effects of the micromirror array will vary depending on the particular optical arrangement used. In general, it will contain terms including the wavelength of light and the spacing between the mirrors (or the grating period).

One option for achieving the third and fourth angles is to physically orientate the illumination sources so that the output rays of light are incident upon the optical element at the desired angles. That is, the first and second rays of light may not be parallel to the third and fourth rays of light when emitted from their respective illumination sources (i.e., they are already angled with respect to each other). Alternatively, if the illumination sources are parallel but spatially separated (i.e., the first and second rays of light are parallel to the third and fourth rays of light when emitted, such that there is no or only a minimal angular separation between the emitted rays of light from the respective illumination sources), then one or more further optical elements, such as mirrors, lenses, etc. may be used to adjust the optical path of one pair or both pairs of rays so that they are incident upon the optical element at their desired/different angles of incidence. Accordingly, in a first example, the first illumination source is orientated with respect to the second illumination source such that the first and second rays of light are incident upon the optical element at the third angle and the third and fourth rays of light are incident upon the optical element at the fourth angle. In a second example, one or more further optical elements are arranged between the illumination assembly and the optical element such that the first and second rays of light are incident upon the optical element at the third angle and the third and fourth rays of light are incident upon the optical element at the fourth angle. Use of one or more further optical elements may simplify manufacture by allowing the illumination sources to be arranged parallel but spatially separate. Additionally, these one or more further optical elements convert the desired third and fourth incidence angles into respective source positions, which can achieve tighter tolerances when machining—this may be particularly useful for compact optical assemblies.

In examples where the optical element optically corresponds to the micromirror array (i.e., n_{OE}=n_{micromirror} and p_{OE}=p_{micromirror}), the angles of incidence may be substantially the same. For example, they may be incident normal to the grating/optical element.

The first ray and the second ray may be spatially separated from the third ray and the fourth ray at their incidence on the angularly dispersive optical element. This can allow the first, second, third and fourth rays to be substantially colinear at the output of the micromirror array. In the above examples, the angles of incidence upon the micromirror array are controlled by use of an optical element. However, in other examples, the angles of incidence may be controlled in a different manner, without the need for an optical element. For example, in examples where the optical assembly comprises a first illumination source configured to emit the first ray of light having the first wavelength and a second illumination source configured to emit the second ray of light having the second wavelength, the physical orientation of the illumination sources may be adjusted so that the output rays of light are incident upon the micromirror array at the desired angles. That is, the first ray of light may not be parallel to the second ray of light when emitted from their respective illumination sources (i.e., they are already angled with respect to each other). Alternatively, if the illumination sources are parallel but spatially separated (i.e., the first ray of light is parallel to the second ray of light when emitted, such that there is no or only a minimal angular separation between the two emitted rays of light), then one or more optical elements, such as mirrors, lenses, etc. may be used to adjust the optical path of one or both rays so that they are incident upon the micromirror array at their desired/different angles of incidence. It will be appreciated, as will be discussed below, these two arrangements may only be suitable only for illumination sources having a very narrow or negligible linewidth (Δ≈0). In some scenarios, a laser may be assumed to have a negligible linewidth by having a linewidth of around 1 nm. Arranging LEDs in this way (without use of an intermediate optical element), will only compensate for the inter-source dispersive effects of two wavelengths (one for each LED) since it is not possible to adjust the angles of incidence of the rays (within the beam of an LED) relative to each other—i.e. the intra-source dispersive effects cannot be corrected in this way. Accordingly, the optical assembly may comprise: a first illumination source, configured to emit the first ray of light having the first wavelength and a second illumination source, configured to emit the second ray of light having the second wavelength, wherein one of: (i) the first illumination source is orientated with respect to the second illumination source such that the first ray of light is incident upon the micromirror array at the first angle of incidence and the second ray of light is incident upon the micromirror array at the second angle of incidence; and (ii) one or more optical elements are arranged between the optical assembly and the micromirror array such that the first ray of light is incident upon the micromirror array at the first angle of incidence and the second ray of light is incident upon the micromirror array at the second angle of incidence. This arrangement may avoid the need for complex optical elements such as diffraction gratings and secondary micromirror arrays.

In a particular example, the first and second illumination sources are lasers. Lasers, in contrast to LEDs, for example, are narrow-band illumination sources.

In a particular example, the first illumination source is orientated with respect to the second illumination source by the predetermined amount. In examples, the one or more optical elements are not angularly dispersive.

In examples where the rays are incident upon an optical element before reaching the micromirror array, there may be an appropriate optical element (such as a diffraction grating and/or second micromirror array) for the first and second wavelengths. For example, the first ray of light may be incident upon a first optical element and the second ray of light may be incident upon a second optical element, where each optical element is designed or selected to be appropriate for each dominant wavelength. This can avoid having to select a single optical element that is suitable for all wavelengths, which may be more expensive to produce. Accordingly, in some examples, the optical assembly comprises: a first illumination source, configured to emit the first ray of light having the first wavelength and a second illumination source, configured to emit the second ray of light having the second wavelength, a first angularly dispersive optical element arranged in an optical path between the first illumination source and the micromirror array, and a second angularly dispersive optical element arranged in an optical path between the second illumination source and the micromirror array. The first and second optical elements have a substantially equal and opposite angularly dispersive effect to that of the micromirror array, and are arranged such that the first ray of light is incident upon the micromirror array at the first angle of incidence and the second ray of light is incident upon the micromirror array at the second angle of incidence.

According to a second aspect of the present invention there is provided a method, comprising: emitting a first ray of light having a first wavelength and a second ray of light having a second wavelength, the second wavelength being different to the first wavelength; controlling an angle of incidence of the first ray of light upon a micromirror array, such that the first ray of light is incident upon the micromirror array at a first angle of incidence; and controlling an angle of incidence of the second ray of light upon the micromirror array, such that the second ray of light is incident upon the micromirror array at a second angle of incidence; wherein the second angle of incidence is different to the first angle of incidence by a predetermined amount to at least partially compensate for the dispersive effects of the micromirror array along an optical axis of the holographic display. In some examples, the wavelength-dependent dispersive effects of the micromirror array are at least partially compensated for, such as reduced or removed, along an optical axis of the holographic display.

In one example, controlling an angle of incidence of the first ray of light upon a micromirror array and controlling an angle of incidence of the second ray of light upon the micromirror array, comprises emitting the first and second rays of light towards an angularly dispersive optical element to introduce a first wavelength-dependent dispersive effect. The micromirror array introduces a second wavelength-dependent dispersive effect substantially equal and opposite in direction to the first wavelength-dependent dispersive effect. As such, the first wavelength-dependent dispersive effect causes the first and second rays of light to be transmitted from the optical element in different directions and are separated by an angle equal to the predetermined amount.

In certain examples, emitting the first ray of light having the first wavelength and the second ray of light having the second wavelength, comprises: emitting the first ray of light from a first illumination source; and emitting the second ray of light from a second illumination source.

In alternative examples, emitting the first ray of light having the first wavelength and the second ray of light having the second wavelength, comprises: emitting the first and second rays of light from the same illumination source. The illumination source may be a first illumination source, for example.

In some arrangements, the method comprises: (i) emitting the first and second rays of light from a first illumination source, (ii) emitting, from a second illumination source, a third ray of light having a third wavelength and a fourth ray of light having a fourth wavelength, towards the angularly dispersive optical element to introduce a first wavelength-dependent dispersive effect on the third and fourth rays of light, wherein the micromirror array introduces a second wavelength-dependent dispersive effect on the third and fourth rays of light that is substantially equal and opposite in direction to the first wavelength-dependent dispersive effect, (iii) controlling an angle of incidence of the first and second rays of light emitted by the first illumination source upon the optical element, such that the first and second rays of light are incident upon the micromirror array at a third angle of incidence, and (iv) controlling an angle of incidence of the third and fourth rays of light emitted by the second illumination source upon the optical element, such that the third and fourth rays of light are incident upon the micromirror array at a fourth angle of incidence, wherein the third and fourth angles of incidence are different. As discussed earlier, this additional compensation may be required when the optical element is not “perfect” for both wavelengths, and instead favours a particular wavelength (i.e., n_{micromirror}≠n_{OE}). This may be for example be designed for the dominant wavelength.

The first ray and the second ray may be spatially separated from the third ray and the fourth ray at their incidence on the angularly dispersive optical element. In some examples, emitting the first ray of light having the first wavelength and the second ray of light having the second wavelength, comprises: emitting the first ray of light from a first illumination source; and emitting the second ray of light from a second illumination source. Controlling an angle of incidence of the first ray of light upon a micromirror array and controlling an angle of incidence of the second ray of light upon the micromirror array, comprises one of: (i) orientating the first illumination source and second illumination source with respect to each other such that the first ray of light is incident upon the micromirror array at the first angle of incidence and the second ray of light is incident upon the micromirror array at the second angle of incidence; and (ii) controlling the light path of at least one of the first ray of light and the second ray of light such that the first ray of light is incident upon the micromirror array at the first angle of incidence and the second ray of light is incident upon the micromirror array at the second angle of incidence. In some examples, controlling the light path comprises arranging one or more mirrors or lenses along the light path to adjust the direction of the light path.

In some examples, emitting the first ray of light having the first wavelength and the second ray of light having the second wavelength, comprises: emitting the first ray of light from a first illumination source; and emitting the second ray of light from a second illumination source. Controlling an angle of incidence of the first ray of light upon a micromirror array and controlling an angle of incidence of the second ray of light upon the micromirror array, comprises: emitting the first ray of light towards a first angularly dispersive optical element to reflect the first ray of light towards the micromirror array such that it is incident upon the micromirror array at the first angle of incidence; and emitting the second ray of light towards a second angularly dispersive optical element to reflect the second ray of light towards the micromirror array such that it is incident upon the micromirror array at the second angle of incidence.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a diagrammatic representation of an example micromirror array in an “on” state;

FIG. 2 is a diagrammatic representation of an example micromirror array in an “off” state;

FIG. 3 is an example representation of the dispersive effects of an example micromirror array;

FIG. 4 depicts spectral curves for example red (R), green (G) and blue (B) LEDs;

FIG. 5 depicts an example arrangement to compensate for the inter-source dispersive effects of an example micromirror array when using narrowband illumination sources;

FIG. 6 illustrates how the arrangement of FIG. 5 only partially compensates for the dispersive effects of an example micromirror array when using broadband illumination sources;

FIG. 7 is a diagrammatic representation of an example optical element used to compensate for the intra-source dispersive effects of an example micromirror array;

FIG. 8A is a first diagrammatic representation of an example optical element used to compensate for both inter-source and intra-source dispersive effects of an example micromirror array when using broadband illumination sources;

FIG. 8B is a second diagrammatic representation of an example optical element used to compensate for both inter-source and intra-source dispersive effects of an example micromirror array when using broadband illumination sources;

FIG. 9 illustrates how the arrangements of FIGS. 8A and 8B compensate for both inter-source and intra-source dispersive effects of an example micromirror array when using broadband illumination sources; and

FIG. 10 is an example flow diagram illustrating an example method of compensating for the dispersive effects of a micromirror array.

### DETAILED DESCRIPTION

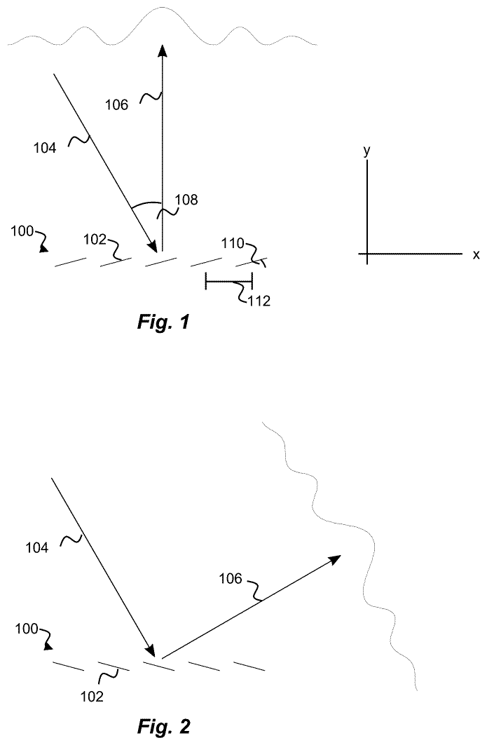

FIG. 1 depicts a diagrammatic representation of a cross section of an example micromirror array 100 (which in this example takes the form of a digital micromirror device, DMD) comprising an array of adjustable micromirrors 102, each representing a pixel (or part of a pixel) in the holographic image to be displayed. Such a DMD 100 may be found within a holographic display used to display a computer-generated hologram.

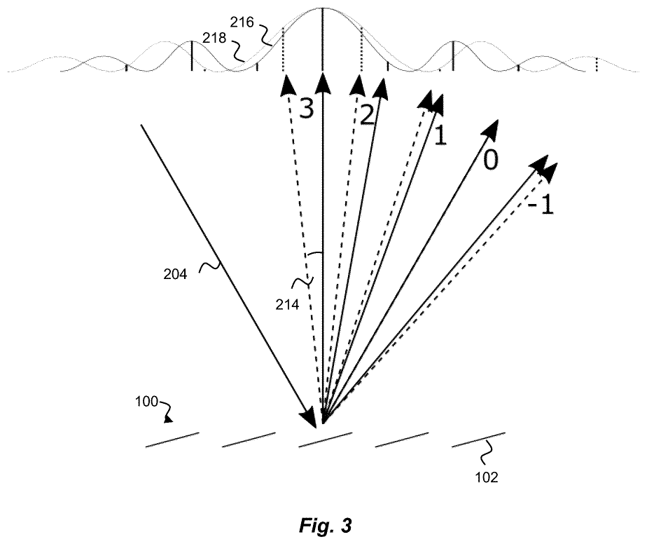

Each micromirror 102 may be rotated via an electrostatic force between the micromirror 102 and electrodes (not shown) positioned below each micromirror 102. Typically, the micromirrors 102 can be rotated between around ±100 to ±20°, and may be in an “on” or “off” state. In the on state, light from an illumination source is reflected in a desired direction (such as normal to the plane of the DMD 100, as shown in FIG. 1) where it may pass through one or more further optical components (such as lenses) of the holographic display to display a pixel (or part of a pixel) for viewing by a user. In the off state, the micromirrors 102 are rotated into a different orientation, and light is directed elsewhere (usually onto an absorption element, such as a ray dump), so that no light is seen by the user for that pixel. In the on state, the micromirrors 102 may be arranged in the position shown in FIG. 1, and in the off state, the micromirrors 102 may be arranged in the position shown in FIG. 2. As shown in FIG. 2, the angle at which the micromirrors 102 are arranged is different to that in FIG. 1.

FIGS. 1 and 2 both show a ray of light 104 incident upon the DMD 100 before being reflected. In FIG. 1, the reflected ray of light 106 is reflected in the desired direction (i.e., in a direction parallel to the normal of the DMD 100), and in FIG. 2, the reflected ray of light 106 is reflected in towards an absorption element. Although FIGS. 1 and 2 show all of the micromirrors 102 arranged in the same position (i.e., all on or all off), it will be appreciated that the micromirrors 102 can be individually controlled, so that some may be arranged in the on position, and some may be arranged in the off position at any one time.

As mentioned, DMDs 100 behave in the same way as a diffraction grating, and so produce diffraction patterns with peaks and troughs as light rays reflected from the micromirrors 102 interfere with each other. FIGS. 1 and 2 therefore show a grating efficiency Sinc² profile of the diffracted light. In this particular example, the grating efficiency peak contains the highest energy of the diffracted light because the wavelength is the blaze wavelength for this particular DMD 100.

FIG. 1 shows a single collimated ray of light 104 incident upon the DMD 100 at a particular angle of incidence 108 (where the angle of incidence is measured from the normal (the y-axis as depicted) of a plane defined by the DMD 100 (the x-axis as depicted). The angle of reflection, θₒᵤₜ, of the reflected ray of light 106 having the highest energy (i.e., where the peak of the Sinc² profile occurs) is similarly measured from the normal. In the example of FIG. 1, θₒᵤₜ=0° (i.e., it lies along the normal) for the particular reflected ray 106.

It can be shown mathematically that an angle of reflection of 0° for the peak of the Sinc² profile can be achieved by setting the angle of incidence, θ₁, equal to twice the mirror tilt angle, θₘᵢᵣᵣₒᵣ, 110 in the on state. Accordingly, in FIG. 1, θ₁=2θₘᵢᵣᵣₒᵣ. It is therefore apparent that changing the angle of incidence or the mirror tilt angle adjusts the position of the Sinc² profile. For example, in FIG. 2, the angle of incidence is the same as in FIG. 1, but the mirrors are angled differently, meaning the reflected light 106 no longer lies along the normal.

Furthermore, as is well known, the angle of reflection, θₒᵤₜ, of any output ray can be calculated using the equation: sin(θₒᵤₜ)=sin(θᵢ)−nλ/p, where n is an integer (the diffraction order), λ is the wavelength of the light ray, and p is the pixel pitch 112 of the DMD 100. In this way, the position of the peaks in the diffraction pattern can be determined.

Each ray leaving the optical element will therefore have an output angle (θₒᵤₜ) which depends on its wavelength (λ) and its incidence angle on the optical element (θᵢ). The difference between output angles of two rays can be calculated using:

$$Δ θ = arcsin ( sin ( {θ}_{i 2} ) - ( n / p ) * {λ}_{2} ) - arc sin ( sin ( {θ}_{i 1} ) - ( n / p ) * {λ}_{1} )$$

This angular separation (which may be a predetermined amount) depends on the wavelength and incidence angles of the rays. This predetermined amount may be different for each pair of rays.

As mentioned, for spectrally broadband sources (e.g., LEDs), the diffractive properties of the DMD 100 reduce the quality of the output reconstructed image because a diffraction pattern is produced for each wavelength and the angular positions of the peaks for each light ray are different for each wavelength. In other words, the corresponding non-zero diffraction orders for each wavelength do not occur at the same angular position. More particularly, the particular diffraction order where the maximum intensities occur for each wavelength do not occur at the same angular position.

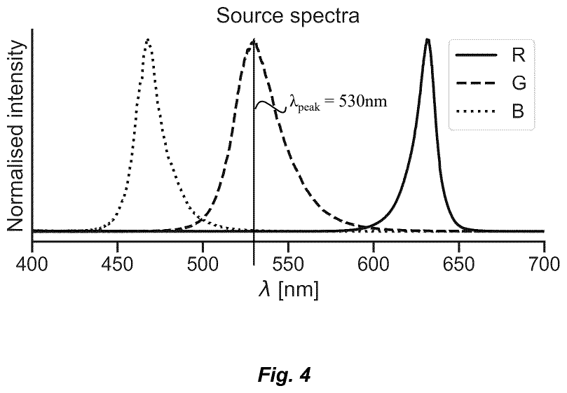

FIG. 3 shows an example in which incident light 204 comprises light rays having two different wavelengths, each being incident upon the DMD 100 at the same angle of incidence, while also satisfying θᵢ=2θₘᵢᵣᵣₒᵣ, so that the grating efficiency peak of both Sinc² envelopes are at 0° from the normal in this “on” state. In this example, the incident light 204 from one or more illumination sources (not shown) comprises a first ray of light having a first wavelength and a second ray of light having a second wavelength, where the second wavelength is different to the first wavelength. In other examples, there may be three or more rays having three or more different wavelengths. In a particular example, both the first and second rays may be emitted from a single broadband source, such as an LED.

FIG. 3 depicts the dispersive nature of the DMD 100, and two separate diffraction patterns are produced (one diffraction pattern for each ray) due to their different wavelengths. For example, the reflected light of the first ray (shown with solid lines) produces a first diffraction pattern, and the reflected light of the second ray (shown with dashed lines) produces a second diffraction pattern, and the non-zero diffraction orders (1, 2, 3, etc.) of both diffraction patterns do not coincide/overlap. For simplicity, only two diffraction patterns are shown (corresponding to the two incident rays of light having different wavelengths), however, it will be appreciated that there may be a plurality of diffraction patterns produced for the plurality of wavelength emitted by an illumination source. For example, an LED may emit a plurality of light rays, each ray having a different wavelength.

The vertical lines shown within the Sinc² envelopes 216, 218 occur at whole integer diffraction orders and their lengths illustrate the relative intensity of the diffraction pattern at that diffraction order. In this example, the diffraction order having the highest/maximum intensity for both wavelengths occurs at the third diffraction order (n=3). Lower intensity reflections occur at different diffraction orders, as indicated by the vertical extent of the lines drawn at other diffraction orders.

In this example, the peak of the first Sinc² envelope 216 for the first ray of light occurs at the third diffraction order (n=3), which corresponds to the maximum intensity for the first light ray, because the first wavelength corresponds to the blaze wavelength. In contrast, the peak of the second Sinc² envelope 218 for the second ray of light does not occur at the same location as the maximum intensity for the second light ray. Instead, the peak of the second Sinc² envelope 218 occurs between the second and third diffraction orders. The angle 214, between the whole integer diffraction orders (in this case n=3) nearest the maximum intensity for both reflected rays is shown in FIG. 3. This means that the rays are effectively being reflected in different directions, which can reduce the quality of the displayed reconstructed image.

In this example, the diffraction orders for where the maximum intensities occur is the same (n=3), which may be the case when the difference between the first and second wavelengths is relatively small, such as when both rays are emitted from a single illumination source (such as a single LED). However, in examples where the difference between the first and second wavelengths is relatively large (which may be the case when the rays are emitted from different illumination sources, such as different LEDs), the difference between the diffraction orders for where the maximum intensities occur could be equal to or greater than 1. As an example, green light reflecting from a DMD 100 may have a maximum intensity at the sixth (n=6) diffraction order, blue light may have a maximum intensity at the seventh (n=7) diffraction order, and red light may have a maximum intensity at the fifth (n=5) diffraction order. In one example, if the first and second rays are both from the same LED, both rays will have a maximum intensity at the same diffraction order. In another example, if one ray is from the blue LED, and the other ray is from the red LED, the difference between the diffraction orders where the maximum intensity occurs will be equal to 2.

As discussed, it may be desirable to use LEDs as illumination sources within a holographic display. Typically, LEDs do not emit a single wavelength ray of light, but may instead emit a plurality of rays having similar but different wavelengths around a dominant wavelength. Although the difference in wavelength between any two emitted rays may be relatively small, it may be great enough to affect the quality of the displayed reconstructed image, for the reasons illustrated in FIG. 3.

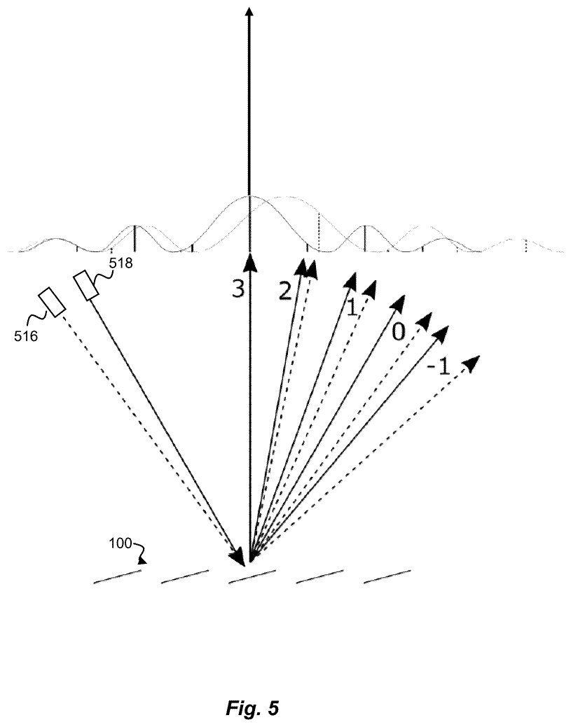

FIG. 4 shows spectral curves for example red (R), green (G) and blue (B) LEDs. FIG. 4 therefore shows the broad spectrum of the LED illumination sources that may be used in an example holographic display.

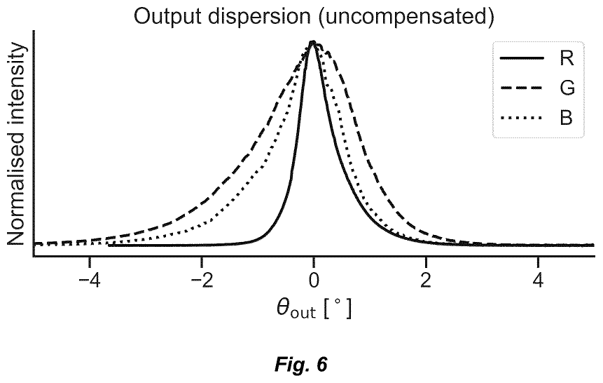

One method to compensate for the dispersive effects of the DMD is to use illumination sources that have a negligible spectral bandwidth, such as lasers, and arrange the illumination sources with respect to each other so that the rays (assumed to have a single, well defined wavelength), are incident upon the DMD 100 at the different angles of incidence, where the difference is sufficient to compensate for the inter-source dispersive effects of the DMD 100 along a particular direction (in this case a normal to the DMD 100). The use of illumination sources that have a negligible spectral bandwidth removes the need to further compensate for intra-source dispersion. To illustrate this, FIG. 5 shows an arrangement in which there are two separate illumination sources 516, 518 and these are arranged/orientated with respect to each other. In this example, the first illumination source 516 emits a first ray of light having a first wavelength and a second illumination source 518 emits a second ray of light having a second wavelength, and the first illumination source 516 is orientated with respect to the second illumination source 518 such that the first ray of light is incident upon the micromirror array at a first angle of incidence and the second ray of light is incident upon the micromirror array at a second angle of incidence, and the second angle of incidence is different to the first angle of incidence by an amount to compensate for the inter-source dispersive effects of the DMD along the particular direction (such as the normal). For example, the difference between the angles of incidence may be equal to the angular separation between the maximum intensities of the diffraction patterns for the case when the angles of incidence are equal (i.e., the angle 214, shown in FIG. 3).

FIG. 5 therefore shows that by adjusting the angle of incidence of the second ray of light by a certain amount, the diffraction orders for the highest intensity reflected rays now coincide. Accordingly, the angular separation of the input rays causes the maximum intensity orders (n=3 for both rays) to overlap at the output of the DMD. Accordingly, in contrast to the example shown in FIG. 3, the n=3 diffraction orders now coincide along the optical axis (in this case the normal). Because the angle of incidence of the second light ray has changed (compared to that shown in FIG. 3), the Sinc² profile has moved.

It will be appreciated that this solution would not fully compensate for all of the dispersive effects introduced by the DMD 100 if the illumination sources 516, 518 were broadband emitters (such as LEDs), because within each beam of light emitted by the LEDs, there are a plurality of rays of light having different wavelengths. As such, the arrangement of FIG. 5, only holds true for the case of monochromatic illumination sources (where the linewidths, Δ≈0). When each illumination source instead has a spectral bandwidth Δ>0 (such as an LED) then arranging the illumination sources in this way would not angularly separate rays (having different wavelengths) emitted within an illumination source. At best, arranging two LEDs in this way would compensate for the dominant wavelength of each source, but not the other wavelengths. As such, there would still be some intra-source dispersion present because the intensity of each wavelength from an LED is “dispersed” over a range of output angles.

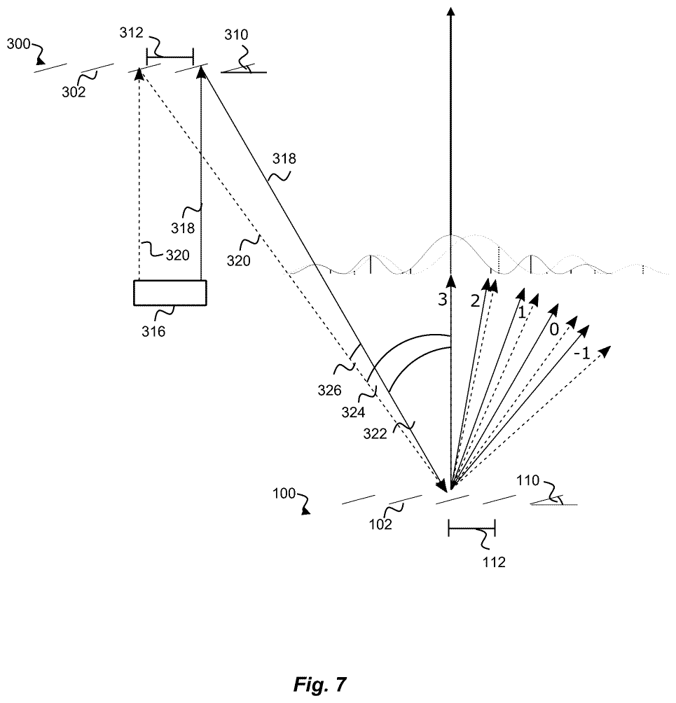

FIG. 6 shows the result of arranging three LEDs at different angles to each other (in the same way as depicted in FIG. 5). While the spectral peaks all coincide around the normal (θₒᵤₜ=0) (so inter-source dispersion has been compensated for), there is still intra-source dispersion present, as shown by the widths of the three curves. FIG. 6 therefore shows a large spread in θₒᵤₜ, and it is desirable to reduce the spread/widths of each curve, to produce a higher quality reconstructed image. This therefore shows that the arrangement in FIG. 5 is less useful when using broadband illumination sources, such as LEDs.

The graph depicted in FIG. 6 was produced using an example DMD from Texas Instruments™, in this case the DLP670S model DMD and 3 example LEDs from Thorlabs™ (in this case, models: M625F2, M530F2 and M470F3). This particular DMD has a mirror tilt angle θₘᵢᵣᵣₒᵣ=17.5°, and a pixel pitch, p=5.4 μm.

When using one or more LEDs, the inventors have realised that the intra-source dispersive effects of the DMD 100 can be compensated for along a particular direction (such as the direction normal to the DMD) by using an angularly dispersive optical element, such as a second DMD or a diffraction grating, where the optical element has a substantially equal and opposite angularly dispersive effect to that of the DMD. The use of such an optical element therefore “pre-disperses” the rays in an equal-but-opposite way before they are incident upon the DMD. In contrast to the arrangement of FIG. 5 (when used with LEDs), the optical element provides a wavelength-dependent output angle for each and every wavelength, which becomes a wavelength dependent incidence angle at the DMD.

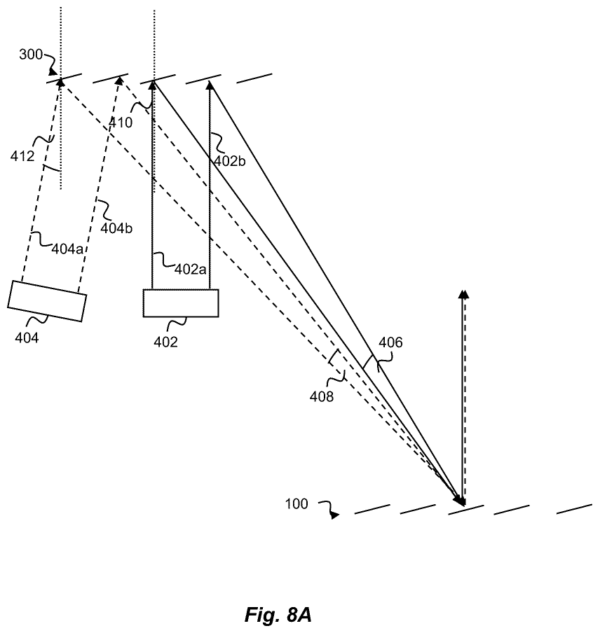

FIG. 7 shows an example arrangement that can be used to compensate for the intra-source dispersive effects of the DMD 100 when using LEDs, and thereby improve the quality of a displayed reconstructed image, by altering/controlling the angle of incidence of light having different wavelengths.

As mentioned, to achieve this, the holographic display additionally comprises an angularly dispersive optical element 300, such as a second DMD or a diffraction grating, where the optical element 300 has a substantially equal and opposite angularly dispersive effect to that of the DMD 100.

In addition to the optical element 300, FIG. 7 shows an illumination assembly 316 configured to emit a first ray of light 318 having the first wavelength and a second ray of light 320 having the second wavelength, towards the optical element 300. In this example, the illumination assembly 316 comprises a single illumination source, such as an LED. In other examples, the illumination assembly 316 may comprise two or more illumination sources, such as first and second illumination sources.

The optical element 300 is arranged to introduce an equal but opposite dispersive effect to that of the DMD 100, thereby to “cancel out” the dispersive effects introduced by the DMD 100. Accordingly, the optical element 300 may behave in substantially the same way as the DMD 100, such that two diffraction patterns are produced when the light diffracts from the optical element 300 in the same way as illustrated and described in relation to FIG. 3. This diffracted/reflected light then travels towards the DMD 100, and each ray is incident upon the DMD 100 at a different angle of incidence. The rays 318, 320 shown between the optical element 300 and the DMD 100 are where the maximum intensities of each wavelength occurs. It will be appreciated that there will also be zero-order and higher-order diffraction paths, but these are omitted for simplicity. When each of these highest intensity rays undergo further dispersion due to the DMD 100, the dispersion is equal and opposite in direction to the dispersion introduced by the optical element 300. Thus, FIG. 7 shows the intra-source dispersive effects of the DMD 100 being compensated for along a desired direction (in this case, along a direction parallel to the normal of the DMD 100).

Accordingly, in this example, the third diffraction orders of both rays overlap along the desired direction. Counteracting the DMD's diffractive effects by “pre-dispersing” the rays with an optical element 300 greatly reduces the intra-source dispersion of the reflected rays from the DMD 100, meaning that the resulting reconstructed image quality is improved.

FIG. 7 therefore depicts the first ray of light 318 (having first being reflected from the optical element 300) incident upon the DMD 100 at a first angle of incidence 322 and the second ray of light (having first being reflected from the optical element 300) incident upon the DMD 100 at a second angle of incidence 324. The second angle of incidence 324 is different to the first angle of incidence 322 by a predetermined amount to compensate for the intra-source dispersive effects of the DMD 100 along the optical axis of the holographic display. As such, the difference 326 is equal to θₒᵤₜ (angle 214, shown in FIG. 3). Thus, when the DMD introduces angular dispersion of −θₒᵤₜ, the two are cancelled out, meaning that a particular diffraction order of both rays overlap along the desired direction (the particular diffraction order being the order having the highest intensity for the wavelength of that ray).

FIG. 7 shows the first and second rays 318, 320 incident upon the optical element 300 being parallel and with spatial separation. This ensures the resultant rays from the DMD 100 are colinear (so are not spatially separated).

It will be appreciated that for one, and in some cases both rays of light, the peak of the Sinc² profile may be offset from the optical axis because the angle of incidence upon the DMD 100 does not satisfy θᵢ=2θₘᵢᵣᵣₒᵣ.

It can be determined, mathematically, that for each ray of light, the overall system of FIG. 7 (where the optical element 300 and DMD 100 are parallel) can be described by: sin(θₒᵤₜ)=sin(θᵢ)+n_{OE}λ/p_{OE}+n_{micromirror}λ/p_{micromirror}, where θₒᵤₜ is the angle of reflection for the ray reflected from the DMD 100 (in this case θₒᵤₜ=0, so sin(θₒᵤₜ)=0), θᵢ is the angle of incidence for the ray on the optical element 300 (in this case θᵢ=0, so sin(θᵢ)=0), n_{OE} is the diffraction order of the maximum intensity of the diffraction pattern at the optical element 300, and n_{micromirror} is the diffraction order of the maximum intensity of the diffraction pattern at the DMD 100. In this particular example where sin(θₒᵤₜ)=0 and sin(θᵢ)=0, this then gives the relationship: n_{OE}/p_{OE}=n_{micromirror}/p_{micromirror}.

For scenarios where the optical element 300 and the DMD 100 are not parallel (that is, the optical element 300 is rotated by an angle θₚₗₐₙₑ relative to the DMD 100), the system can be described by: sin(θₒᵤₜ)=cos(θₚₗₐₙₑ)[sin(θᵢ)+n_{OE}λ/p_{OE}]+sin(θₚₗₐₙₑ)[sqrt(1−(sin(θᵢ)+n_{OE}λ/p_{OE})²]+n_{micromirror}λ/p_{micromirror}. When θₚₗₐₙₑ=0, and θᵢ=0 the equation reduces to the parallel plane case above.

In one example, the optical element 300 is a diffraction grating, such as a reflective diffraction grating. To effectively compensate for the dispersive effects of the DMD 100, the diffraction grating may be manufactured or selected that has a substantially equal angularly dispersive effect to that of the DMD 100. For example, the blaze angle 310 may be substantially the same as the mirror tilt angle 110 in the “on” state, and the pitch 312 may be substantially the same as the pixel pitch 112 of the DMD 100.

In another example, the optical element 300 is a second micromirror array, such as a DMD. To effectively compensate for the dispersive effects of the DMD 100, the second micromirror array may have a substantially equal dispersive effect to that of the DMD 100. For example, the mirror tilt angle 310 may be substantially the same as the mirror tilt angle 110 in the “on” state, and the pixel pitch 312 may be substantially the same as the pixel pitch 112 of the DMD 100.

Although it is preferable to select an optical element 300 that is optically identical to the DMD 100, sufficient correction of the intra-source dispersion can be achieved by selecting an optical element that satisfies: n_{OE}/p_{OE}=n_{micromirror}/p_{micromirror}. In the example discussed above using a green LED, then n_{micromirror}˜6, p_{micromirror}=5.4 μm, and as such, could be compensated for by using an optical element 300 having n_{OE}˜1 and p_{OE}=0.9 μm. For example, “off-the-shelf” diffraction gratings are typically blazed for n=1. However, a more preferable optical element 300 would have n_{OE}=n_{micromirror} and p_{OE}=p_{micromirror}.

As discussed above, for a typical DMD, the peak red, green and blue reflected rays represent different diffractive orders from the DMD. This complicates the process of compensating the dispersive effects (both inter-source and intra-source) of all 3 coloured LEDs. For the example DMD and LEDs discussed above (where the pixel pitch is 5.4 μm and θₘᵢᵣᵣₒᵣ=17.5°), n_{R}=5, n_{G}=6 and n_{B}=7. As mentioned above, the most effective solution for compensating for all wavelengths is to use an optical element 300 that has: n_{OE}=n_{micromirror} and p_{OE}=p_{micromirror} and illuminating the optical element 300 at normal incidence for all LEDs. However, in cases where no such diffraction grating is readily available, and other options, such as using a second DMD, may be too expensive, then an optical element is selected that satisfies: n_{OE}/p_{OE}=n_{micromirror}/p_{micromirror}. Further compensation may be needed, because n_{micromirror} differs for each colour LED.

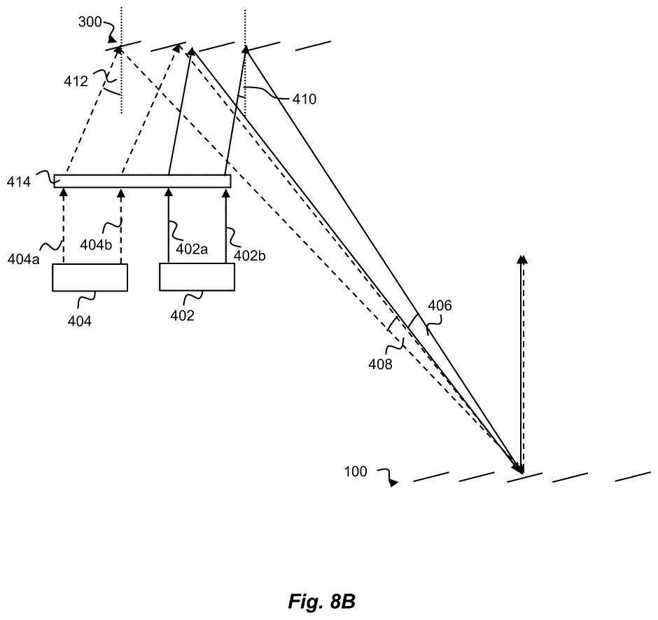

This additional compensation can be made by adjusting the angle of incidence upon the optical element 300, so that light rays from different LEDs are no longer incident on the optical element 300 at the same angle. This is not depicted in FIG. 7, which instead shows both the first and second rays of light 318, 320 incident upon the optical element 300 at the same angle of incidence. (FIGS. 8A and 8B, discussed below, do depict this adjustment in angle of incidence.) This additional adjustment compensates for the fact that an optical element may have been selected that is more suitable to correct the dispersive effects for one of the wavelengths, and less suitable for the other(s). This effectively combines the arrangements of FIG. 5 (by adjusting the angle of the illumination sources relative to each other, which compensates for the inter-source dispersive effects introduced by the DMD), with the optical element 300 of FIG. 7, which compensates for the intra-source dispersive effects introduced by the DMD. The light rays from different LEDs are also spatially separated from each other when incident on the optical element. This results in the first and second rays of a first illumination source being substantially colinear with a third and fourth ray (having third and fourth wavelengths) of a second illumination source at the output of the DMD, where all four rays are also colinear with an optical axis of the holographic display.

As such, the optical element 300 compensates for the difference between the first and second wavelengths of the first and second light rays emitted by the first illumination source, as well as compensating for the difference between the third and fourth wavelengths of the third and fourth light rays emitted by the second illumination source. Further, to compensate for the inter-source dispersion, the first illumination source is arranged such that the first and second rays of light are incident upon the optical element at a third angle, and the second illumination source is arranged such that the third and fourth rays of light are incident upon the optical element at a fourth angle.

To illustrate this, FIG. 8A depicts an example arrangement that combines the concepts discussed in FIGS. 5 and 7. This arrangement therefore compensates for both intra-source dispersive effects and inter-source dispersive effects when an optical element has been selected that is more suitable to correct the dispersive effects for one of the wavelengths, and less suitable for the other.

FIG. 8A therefore depicts the DMD 100, an optical element 300, and an illumination assembly comprising a first illumination source 402 and a second illumination source 404. The first illumination source 402 is configured to emit a first plurality of rays of light having a range of wavelengths including a first ray of light 402a having a first wavelength and a second ray of light 402b having a second wavelength. The first illumination source 402 in this example is an LED, such as a red LED. The second illumination source 404 is configured to emit a second plurality of rays of light having a range of wavelengths including a third ray of light 404a having a third wavelength and a fourth ray of light 404b having a fourth wavelength. The second illumination source 404 in this example is an LED, such as a blue LED. Further illumination sources may also be present, such as a green LED.

The first illumination source 402 is arranged such that the first and second rays of light 402a, 402b are incident upon the optical element 300 at a third angle 410 (in this case the angle of incidence upon the optical element 300 is 0°, but other angles may be used) and the second illumination source 404 is arranged such that the third and fourth rays of light 404a, 404b are incident upon the optical element at a fourth angle 412, where the third and fourth angles are different. This “offset” in angle of incidence upon the optical element 300 therefore compensates for the inter-source dispersion i.e. the spectral peaks all coincide around the surface normal of the DMD (theta_out=0), as shown in FIG. 6. In examples where n_{OE}=n_{micromirror} and p_{OE}=p_{micromirror}, the third and fourth angles 410, 412 may be the same. For example, the first, second, third and fourth rays of light may all be incident normal to the optical element 300. In addition to this “offset” in angle of incidence upon the optical element 300, rays emitted by each illumination source may also be spatially separated. This ensures the resultant rays from the DMD 100 are colinear (so are not spatially separated at the output of the DMD).

As mentioned above, the optical element 300 has a substantially equal and opposite angularly dispersive effect to that of the micromirror array, such that: (a) the first and second rays of light 402a, 402b are transmitted from the optical element 300 in different directions and are separated by an angle 406 equal to a predetermined amount to at least partially compensate for the dispersive effects of the DMD 100 along the optical axis of the holographic display, and (b) the third and fourth rays of light 404a, 404b are transmitted from the optical element 300 in different directions and are separated by an angle 408 equal to a predetermined amount to at least partially compensate for the dispersive effects of the DMD 100 along the optical axis of the holographic display. This therefore compensates for the intra-source dispersion.

As shown in FIG. 8A, the first, second, third and fourth rays of light 402a, 402b, 404a, 404b travel from the illumination sources 402, 404 to the DMD 100 via the optical element 300. The rays 402a, 402b, 404a, 404b shown between the optical element 300 and the DMD 100 are where the maximum intensities of each wavelength occurs. It will be appreciated that there will also be zero-order and higher-order diffraction paths, but these are omitted for simplicity.

In the same way as discussed in FIG. 7, the first ray of light 402a is incident upon the DMD 100 at a first angle of incidence and the second ray of light 402b is incident upon the DMD 100 at a second angle of incidence, the second angle of incidence being different to the first angle of incidence by a predetermined amount to at least partially compensate for the dispersive effects of the DMD 100 along the optical axis of the holographic display. Similarly, the third ray of light 404a is incident upon the DMD 100 at another angle of incidence and the fourth ray of light 404b is incident upon the DMD 100 at further angle of incidence, the angles of incidence being different by a predetermined amount to at least partially compensate for the dispersive effects of the DMD 100 along the optical axis of the holographic display.

In this example where the first illumination source 402 is a red LED, red light reflecting from the DMD 100 (that is, both the first and second rays 402a, 402b) have a maximum intensity at the fifth (n=5) diffraction order. Similarly, in this example where the second illumination source 404 is a blue LED, blue light reflecting from the DMD 100 (that is, both the third and fourth rays 404a, 404 b) have a maximum intensity at the seventh (n=7) diffraction order. Accordingly, in this example, the fifth diffraction orders of the first and second rays 402a, 402b overlap with the seventh diffraction orders of the third and fourth rays 404a, 404b along the desired direction. In examples comprising a third illumination source, such as a green LED, two further rays from the third illumination source would have a maximum intensity at the sixth (n=6) diffraction order overlapping with the first, second, third and fourth rays. The third illumination source may also be arranged relative to the first and second illumination sources in the same way so as to compensate for the inter-source dispersive effects.

As an example, the inventors have found that when using the diffraction grating model GR50-1205 available from Thorlabs™ with red, green and blue LEDs (models: M625F2, M530F2 and M470F3 from Thorlabs™), acceptable correction can be achieved by setting the angle of incidence upon the diffraction grating 300 for the red, green and blue beams of light as θᵢ(R)=−10.0°, θᵢ(G)=−2.7°, θᵢ(B)=2.6° respectively. In this example, for the diffraction grating model GR50-1205, n=1, the blaze angle=17.27° and p=0.83 μm (or 1200 lines/mm)). These values can be calculated using the following equation: sin(θᵢ)=sin(θₒᵤₜ)−n_{OE}λ/p_{OE}+n_{micromirror}λ/p_{micromirror}, where n_{OE}=1 and θₒᵤₜ=0 for the dominant wavelengths of the LEDs, and n_{micromirror}=5, 6 or 7.

As mentioned, as a modification of the arrangement of FIG. 8A, the illumination sources 402, 404 may instead be arranged parallel to each other, rather than being physically orientated with respect to each other. This means that the first and second rays of light 402a, 402b are parallel to the third and fourth rays of light 404a, 404b when emitted, such that there is no or only a minimal angular separation between the emitted rays of light from the respective illumination sources. In such cases, one or more further optical elements, such as a lens, may be used to adjust the optical path of one pair or both pairs of rays so that they are incident upon the optical element 300 at their desired/different angles of incidence 410, 412.

To illustrate, FIG. 8B depicts an arrangement in which there is a further optical element in the form of a lens 414 arranged between the first and second illumination sources 402, 404 and the optical element 300 such that the first and second rays of light 402a, 402b are incident upon the optical element 300 at the third angle 410 and the third and fourth rays of light 404a, 404b are incident upon the optical element 300 at the fourth angle 412. As shown, as the rays 402a, 402b, 404a, 404b travel from their respective illumination sources 402, 404, they are parallel to each other.

It will be appreciated that the principles discussed above can be applied to three illumination sources.

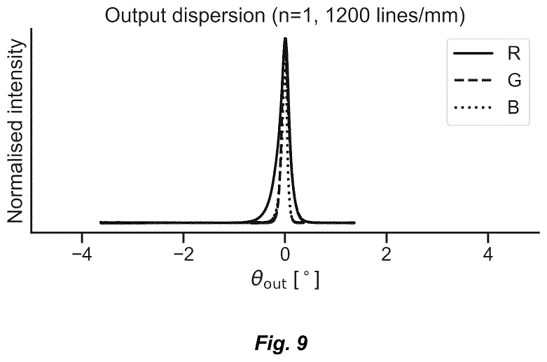

To illustrate the effect of the arrangements of FIGS. 8A and 8B, FIG. 9 shows the same three LEDs of FIGS. 4 and 6 illuminating diffraction grating model GR50-1205, which is only a near-match to the DMD 100. In FIG. 9, the input angles to the grating have been chosen in the same manner as discussed above to ensure that the beams are largely colinear at the DMD output. It can clearly be seen that the intra-source dispersion is greatly reduced by a factor of around ten times (compared to the case in FIG. 6, where there was no optical element 300).

This could be improved even further by using an optical element that exactly matches the DMD (i.e., n_{OE}=n_{micromirror} and p_{OE}=p_{micromirror}).

In contrast to the arrangement of FIG. 5, the compensation introduced by the use of an optical element 300 can be applied in all practical scenarios, and is therefore applicable to both monochromatic illumination sources (Δ=0) and polychromatic illumination sources (Δ>0).

As an alternative arrangement (not shown), each illumination source may be directed towards its own, separate, optical element that is more suitable for that wavelength. For example, a first illumination source (such as an LED) may emit a first ray of light having a first wavelength (as well as other rays having different wavelengths) and a second illumination source (such as an LED) may emit a second ray of light having a second wavelength (as well as other rays having different wavelengths). In that case, there may be a first angularly dispersive optical element to receive the first ray of light from the first illumination source and a second angularly dispersive optical element to receive the second ray of light from the second illumination source. Each optical element may satisfy n_{OE}/p_{OE}=n_{micromirror}/p_{micromirror} for the dominant wavelength emitted by the illumination source. Accordingly, the first and second optical elements have a substantially equal and opposite angularly dispersive effect to that of the DMD, and are arranged such that the first ray of light is incident upon the micromirror array at the first angle of incidence and the second ray of light is incident upon the micromirror array at the second angle of incidence.

In the same way, it will be appreciated that the illumination sources 516, 518 of FIG. 5 may not necessarily be physically orientated with respect to each other, yet the rays emitted by the illumination sources may still be incident upon the DMD 100 at their different angles of incidence. This could be achieved, for example, by using one or more further optical elements, such as mirrors or lenses to manipulate the light path from one or both of the illumination sources such that the rays emitted by the illumination sources may still be incident upon the DMD 100 at their different angles of incidence.

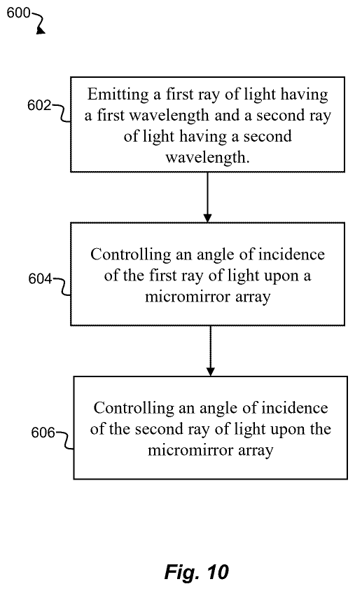

FIG. 10 depicts a flow diagram of a method 600 of at least partially compensating for the dispersive effects of a micromirror array, such as the DMD 100. In block 602, the method comprises emitting a first ray of light having a first wavelength and a second ray of light having a second wavelength, the second wavelength being different to the first wavelength. As mentioned, the first and second rays may be emitted by the same or different illumination sources. Block 604 comprises controlling an angle of incidence of the first ray of light upon a micromirror array, such that the first ray of light is incident upon the micromirror array at a first angle of incidence and block 606 comprises controlling an angle of incidence of the second ray of light upon the micromirror array, such that the second ray of light is incident upon the micromirror array at a second angle of incidence. The second angle of incidence is different to the first angle of incidence by a predetermined amount to at least partially compensate for the dispersive effects of the micromirror array.

In one example, such as that corresponding to the arrangement of FIG. 7, blocks 604 and 606 may comprise: emitting the first and second rays of light towards an angularly dispersive optical element to introduce a first wavelength-dependent dispersive effect, and the micromirror array introduces a second wavelength-dependent dispersive effect substantially equal and opposite in direction to the first wavelength-dependent dispersive effect.

In another example, such as that corresponding to the arrangement of FIG. 5, blocks 604 and 606 may comprise orientating a first illumination source and a second illumination source with respect to each other such that the first ray of light is incident upon the micromirror array at the first angle of incidence and the second ray of light is incident upon the micromirror array at the second angle of incidence. In another example, blocks 604 and 606 may comprise controlling the light path of at least one of the first ray of light and the second ray of light such that the first ray of light is incident upon the micromirror array at the first angle of incidence and the second ray of light is incident upon the micromirror array at the second angle of incidence.

It should be noted that the schematic depictions in FIGS. 5, 7, 8A and 8B are to aid understanding, and the skilled person will be aware that numerous variations can be used in conjunction with the methods described here. For example, other arrangements may include image folding or directing components so that the optical path has a different shape, such as a folded optical path.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A holographic display for displaying a computer-generated hologram, the display comprising:
an angularly dispersive micromirror array; and
an optical assembly configured to emit, towards the micromirror array, a first ray of light having a first wavelength and a second ray of light having a second wavelength, the second wavelength being different to the first wavelength;
wherein the first ray of light is incident upon the micromirror array at a first angle of incidence and the second ray of light is incident upon the micromirror array at a second angle of incidence, the second angle of incidence being different to the first angle of incidence by a predetermined amount to at least partially compensate for the dispersive effects of the micromirror array along an optical axis of the holographic display.

2. A holographic display according to claim 1, wherein the optical assembly comprises:
an illumination assembly configured to emit the first ray of light having the first wavelength and the second ray of light having the second wavelength; and
an angularly dispersive optical element arranged between the illumination assembly and the micromirror array, such that the first and second rays of light travel from the illumination assembly to the micromirror array via the angularly dispersive optical element;
wherein the angularly dispersive optical element has a substantially equal and opposite angularly dispersive effect to that of the micromirror array, such that the first and second rays of light are transmitted from the optical element in different directions and are separated by an angle equal to the predetermined amount.

3. A holographic display according to claim 2, wherein the optical element is a diffraction grating.

4. A holographic display according to claim 3, wherein the diffraction grating has:
a pitch substantially corresponding to a pixel pitch of the micromirror array; and
a blaze angle substantially corresponding to a mirror tilt angle of the micromirror array.

5. A holographic display according to claim 2, wherein the optical element is a second micromirror array.

6. A holographic display according to claim 5, wherein the micromirror array and the second micromirror array have substantially the same pixel pitch and mirror tilt angle.

7. A holographic display according to claim 2, wherein:
maximum intensities of the first ray of light and the second ray of light, reflected from the micromirror array, occur substantially at a particular diffraction order, n_{micromirror}, of each ray;
maximum intensities of the first ray of light and the second ray of light, reflected from the optical element, occur substantially at a particular diffraction order, n_{OE}, of each ray;
the micromirror array has a pixel pitch, p_{micromirror} and the optical element has a pitch, p_{OE}; and
n_{micromirror}/p_{micromirror}=n_{OE}/p_{OE}, such that the angularly dispersive optical element has a substantially equal and opposite angularly dispersive effect to that of the micromirror array.

8. A holographic display according to claim 7, wherein n_{micromirror}=n_{OE} for each ray of light, and p_{micromirror}=p_{OE}.

9. A holographic display according to claim 2, wherein the illumination assembly comprises an illumination source configured to emit a plurality of rays of light having a range of wavelengths, the plurality of rays of light including the first ray of light having the first wavelength and the second ray of light having the second wavelength.

10. A holographic display according to claim 9, wherein the illumination source comprises a light emitting diode, LED.

11. A holographic display according to claim 9, wherein the illumination source is a first illumination source, and the illumination assembly further comprises:
a second illumination source configured to emit a second plurality of rays of light having a second range of wavelengths, the second plurality of rays of light including a third ray of light having a third wavelength and a fourth ray of light having a fourth wavelength, wherein:
the third and fourth rays of light travel from the illumination assembly to the micromirror array via the angularly dispersive optical element;
such that the third and fourth rays of light are transmitted from the optical element in different directions and are separated by a second angle equal to a second predetermined amount to at least partially compensate for the dispersive effects of the micromirror array on the second plurality of rays along the optical axis of the holographic display; and
the first illumination source is arranged such that the first and second rays of light are incident upon the optical element at a third angle, and the second illumination source is arranged such that the third and fourth rays of light are incident upon the optical element at a fourth angle, wherein the third and fourth angles are different.

12. A holographic display according to claim 11, wherein the first ray and the second ray are spatially separated from the third ray and the fourth ray at their incidence on the angularly dispersive optical element.

13. A holographic display, according to claim 1, wherein the optical assembly comprises:
a first illumination source, configured to emit the first ray of light having the first wavelength; and
a second illumination source, configured to emit the second ray of light having the second wavelength;
wherein one of:
the first illumination source is orientated with respect to the second illumination source such that the first ray of light is incident upon the micromirror array at the first angle of incidence and the second ray of light is incident upon the micromirror array at the second angle of incidence; and
one or more optical elements are arranged between the optical assembly and the micromirror array such that the first ray of light is incident upon the micromirror array at the first angle of incidence and the second ray of light is incident upon the micromirror array at the second angle of incidence.

14. A holographic display, according to claim 13, wherein the first and second illumination sources are lasers.

15. A holographic display, according to claim 1, wherein the optical assembly comprises:
a first illumination source, configured to emit the first ray of light having the first wavelength; and
a second illumination source, configured to emit the second ray of light having the second wavelength;
a first angularly dispersive optical element arranged in an optical path between the first illumination source and the micromirror array;
a second angularly dispersive optical element arranged in an optical path between the second illumination source and the micromirror array;
wherein the first and second optical elements have a substantially equal and opposite angularly dispersive effect to that of the micromirror array, and are arranged such that the first ray of light is incident upon the micromirror array at the first angle of incidence and the second ray of light is incident upon the micromirror array at the second angle of incidence.

16. A method, comprising:
emitting a first ray of light having a first wavelength and a second ray of light having a second wavelength, the second wavelength being different to the first wavelength;
controlling an angle of incidence of the first ray of light upon a micromirror array, such that the first ray of light is incident upon the micromirror array at a first angle of incidence; and
controlling an angle of incidence of the second ray of light upon the micromirror array, such that the second ray of light is incident upon the micromirror array at a second angle of incidence;
wherein the second angle of incidence is different to the first angle of incidence by a predetermined amount to at least partially compensate for the dispersive effects of the micromirror array.

17. A method according to claim 16, wherein controlling an angle of incidence of the first ray of light upon a micromirror array and controlling an angle of incidence of the second ray of light upon the micromirror array, comprises emitting the first and second rays of light towards an angularly dispersive optical element to introduce a first wavelength-dependent dispersive effect; and
wherein the micromirror array introduces a second wavelength-dependent dispersive effect substantially equal and opposite in direction to the first wavelength-dependent dispersive effect.

18. A method according to claim 16, wherein emitting the first ray of light having the first wavelength and the second ray of light having the second wavelength, comprises:
emitting the first ray of light from a first illumination source; and
emitting the second ray of light from a second illumination source.

19. A method according to claim 17, wherein emitting the first ray of light having the first wavelength and the second ray of light having the second wavelength, comprises:
emitting the first and second rays of light from the same illumination source.

20. A method according to claim 19, comprising:
emitting the first and second rays of light from a first illumination source;
emitting, from a second illumination source, a third ray of light having a third wavelength and a fourth ray of light having a fourth wavelength, towards the angularly dispersive optical element to introduce a first wavelength-dependent dispersive effect on the third and fourth rays of light, wherein the micromirror array introduces a second wavelength-dependent dispersive effect on the third and fourth rays of light that is substantially equal and opposite in direction to the first wavelength-dependent dispersive effect;
controlling an angle of incidence of the first and second rays of light emitted by the first illumination source upon the optical element, such that the first and second rays of light are incident upon the micromirror array at a third angle of incidence; and
controlling an angle of incidence of the third and fourth rays of light emitted by the second illumination source upon the optical element, such that the third and fourth rays of light are incident upon the micromirror array at a fourth angle of incidence, wherein the third and fourth angles of incidence are different.

21. A method according to claim 20, wherein the first ray and the second ray are spatially separated from the third ray and the fourth ray at their incidence on the angularly dispersive optical element.

22. A method according to claim 16, wherein:
emitting the first ray of light having the first wavelength and the second ray of light having the second wavelength, comprises:
emitting the first ray of light from a first illumination source; and
emitting the second ray of light from a second illumination source; and
controlling an angle of incidence of the first ray of light upon a micromirror array and controlling an angle of incidence of the second ray of light upon the micromirror array, comprises one of:
orientating the first illumination source and second illumination source with respect to each other such that the first ray of light is incident upon the micromirror array at the first angle of incidence and the second ray of light is incident upon the micromirror array at the second angle of incidence; and
controlling the light path of at least one of the first ray of light and the second ray of light such that the first ray of light is incident upon the micromirror array at the first angle of incidence and the second ray of light is incident upon the micromirror array at the second angle of incidence.

23. A method according to claim 16, wherein:
emitting the first ray of light having the first wavelength and the second ray of light having the second wavelength, comprises:
emitting the first ray of light from a first illumination source; and
emitting the second ray of light from a second illumination source; and
wherein controlling an angle of incidence of the first ray of light upon a micromirror array and controlling an angle of incidence of the second ray of light upon the micromirror array, comprises:
emitting the first ray of light towards a first angularly dispersive optical element to reflect the first ray of light towards the micromirror array such that it is incident upon the micromirror array at the first angle of incidence; and
emitting the second ray of light towards a second angularly dispersive optical element to reflect the second ray of light towards the micromirror array such that it is incident upon the micromirror array at the second angle of incidence.
